(19) United States
(12) Patent Application Publication
(10) Pub. No.: US 2018/0001552 A1
(43) Pub. Date: Jan. 4, 2018

(54) METHOD AND APPARATUS FOR THREE-DIMENSIONAL FABRICATION OF CONTINUOUS SHEETS OF MATERIAL

(71) Applicant: Carbon, Inc., Redwood City, CA (US)

(72) Inventors: Gregory W. Dachs, II, San Mateo, CA (US); David Moore, San Carlos, CA (US); Georgios Katsikis, Belmont, CA (US)

(21) Appl. No.: 15/630,307

(22) Filed: Jun. 22, 2017

Related U.S. Application Data
(60) Provisional application No. 62/357,004, filed on Jun. 30, 2016.

(51) Int. Cl. B29C 64/165; B33Y 30/00; B33Y 10/00

(52) U.S. Cl. CPC B29C 64/165; B33Y 10/00; B33Y 30/00

(57) ABSTRACT

A method of forming a three-dimensional object including a continuous sheet of material includes: (a) providing at least one drive roller and a build plate, with the build plate including an optically transparent member, with the optically transparent member including a build surface, and with the build surface at least partially defining a build region and the at least one drive roller adjacent the build region; (b) filling the build region with a polymerizable liquid; (c) irradiating the build region with light through the optically transparent member to form a solid polymer from the polymerizable liquid; and (d) rotating the at least one drive roller to form the three-dimensional object from the solid polymer and/or to advance (or draw) the continuous sheet of material away from the build region.

### RELATED APPLICATIONS

This application claims the benefit of U.S. Provisional Patent Application Ser. No. 62/357,004, filed Jun. 30, 2016, the disclosure of which is incorporated by reference herein in its entirety.

### BACKGROUND

Some three-dimensional printers include a build platform or carrier and a build surface defined by a window. Liquid resin is fed to a build region between the carrier and the build surface and irradiated through the window to form a solid polymer from the liquid resin. The carrier is advanced away from the build surface to form a three-dimensional object from the solid polymer. The three-dimensional object is then removed from the carrier (see, e.g., U.S. Pat. No. 5,236,637 to Hull). Unfortunately, such techniques have been generally considered slow, and are typically limited to resins that produce brittle or fragile objects suitable only as prototypes.

A more recent technique known as continuous liquid interface production (CLIP) allows both more rapid production of objects by stereolithography (see, e.g., U.S. Pat. Nos. 9,205,601; 9,211,678; 9,216,546; 9,360,757; and U.S. Pat. No. 9,498,920 to DeSimone et al.), and the production of parts with isotropic mechanical properties (see R. Janusziewcz et al., Layerless fabrication with continuous liquid interface production, Proc. Natl. Acad. Sci. USA 113, 11703-11708 (Oct. 18, 2016).

Still further, the recent introduction of dual cure additive manufacturing resins by Rolland et al. (see, e.g., U.S. Pat. Nos. 9,676,963; 9,598,606; and 9,453,142), has additionally made possible the production of a much greater variety of functional, useful, objects suitable for real world use.

In some cases, particularly for dual cure resins, it may be desirable for the printer to be configured to print continuous sheets of material which may then be conveyed away from the build surface for further processing such as washing and second cure. This may be particularly advantageous when printing objects at high volume.

### SUMMARY

Some embodiments of the present invention are directed to a method of forming a three-dimensional object including a continuous sheet of material. The method includes: (a) providing at least one drive roller and a build plate, with the build plate including an optically transparent member, with the optically transparent member including a build surface, and with the build surface at least partially defining a build region and the at least one drive roller adjacent the build region; (b) filling the build region with a polymerizable liquid; (c) irradiating the build region with light through the optically transparent member to form a solid polymer from the polymerizable liquid; and (d) rotating the at least one drive roller to form the three-dimensional object from the solid polymer and/or to advance (or draw) the three-dimensional object including the continuous sheet of material away from the build region.

Some other embodiments of the present invention are directed to an apparatus for forming a three-dimensional object including a continuous sheet of material from a polymerizable liquid. The apparatus includes: (a) an optically transparent member having a build surface, with the build surface at least partially defining the build region; (b) first and second drive rollers on opposite sides of and adjacent the build surface; (c) a liquid polymer supply in fluid communication with and configured to supply a liquid polymer or polymerizable liquid into the build region for solidification or polymerization; (d) a radiation source configured to irradiate the build region through the optically transparent member to form a solid polymer from the polymerizable liquid; and (e) at least one controller operatively associated with the first and second drive rollers and the radiation source for rotating the first and second drive rollers to form the three-dimensional object from the solid polymer and to advance the continuous sheet of material away from the build surface.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is perspective view an apparatus related to the present invention.

FIG. 2 is a perspective view of a portion of an apparatus according to some embodiments of the present invention.

FIG. 3 is a fragmentary perspective sectional view of the apparatus of FIG. 2.

FIG. 4 is a fragmentary perspective sectional view of a portion of an apparatus according to some other embodiments of the present invention.

FIG. 5 is a perspective view of a particular embodiment of the apparatus of FIGS. 1-3.

FIG. 6 is a perspective view of a second particular embodiment of the apparatus of FIGS. 1-3.

FIG. 7 is a fragmentary perspective sectional view of a particular embodiment of the apparatus of FIG. 4.

### DETAILED DESCRIPTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises,” “includes,” “comprising,” and/or “including,” when used in this specification, specify the presence of stated features, integers, steps, operations, elements, and/or components, but do not preclude the presence or addition of one or more other features, integers, steps, operations, elements, components, and/or groups thereof.

It is noted that any one or more aspects or features described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail in the specification set forth below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Example of an apparatus related to the present invention (and polymerizable liquids, or “resins” that can be used to carry out the present invention) are given in U.S. Pat. Nos. 9,205,601; 9,211,678; 9,216,546; 9,360,757; and U.S. Pat. No. 9,498,920 to DeSimone et al. It generally comprises a radiation source such as a digital light processor (DLP) providing electromagnetic radiation which though reflective mirror illuminates a build chamber defined by wall and a build plate or window forming the bottom of the build chamber, which build chamber is filled with liquid resin. The top of the object under construction is attached to a carrier. The carrier is driven in the vertical direction by linear stage. The various components are mounted on a support or frame assembly. While the particular design of the support or frame assembly is not critical and can assume numerous configurations, in the illustrated embodiment it is comprised of a base to which the radiation source is securely or rigidly attached, a vertical member to which the linear stage is operatively associated, and a horizontal table to which wall is removably or securely attached (or on which the wall is placed), and with the build plate rigidly fixed, either permanently or removably, to form the build chamber as described above. The apparatus can be further configured and can carry out methods as described therein.

In some embodiments, the polymerizable liquid used is a dual cure polymerizable liquid, such as described by Rolland et al. in U.S. Pat. Nos. 9,676,963; 9,598,606; and 9,453,142.

As will be described in more detail below, embodiments of the present invention effectively replace the carrier with an advancement mechanism that is configured to advance the three-dimensional object including a continuous sheet of material. For example, the advancement mechanism may include at least one drive roller adjacent the build surface or window. According to some embodiments, the “advancing” step described above is effectively replaced with a “rotating” step with the at least one drive roller being rotated to form a three-dimensional object and/or advance the continuous sheet. According to some embodiments, the three-dimensional object is formed by drawing it away from the window in response to rotating the at least one drive roller.

In some embodiments of bottom up or top down three dimensional fabrication as implemented in the context of the present invention, the build surface is stationary during the formation of the three dimensional object or intermediate; in other embodiments of bottom-up three dimensional fabrication as implemented in the context of the present invention, the build surface is tilted, slid, flexed and/or peeled, and/or otherwise translocated or released from the growing three dimensional object or intermediate, usually repeatedly, during formation of the three dimensional object or intermediate.

In some embodiments of bottom up or top down three dimensional fabrication as carried out in the context of the present invention, the polymerizable liquid (or resin) is maintained in liquid contact with both the growing three dimensional object or intermediate and the build surface during both the filling and irradiating steps, during fabrication of some of, a major portion of, or all of the three dimensional object or intermediate.

In some embodiments of bottom-up or top down three dimensional fabrication as carried out in the context of the present invention, the growing three dimensional object or intermediate is fabricated in a layerless manner (e.g., through multiple exposures or “slices” of patterned actinic radiation or light) during at least a portion of the formation of the three dimensional object or intermediate.

In some embodiments of bottom up or top down three dimensional fabrication as carried out in the context of the present invention, the growing three dimensional intermediate is fabricated in a layer-by-layer manner (e.g., through multiple exposures or “slices” of patterned actinic radiation or light), during at least a portion of the formation of the three dimensional object or intermediate.

In some embodiments of bottom up or top down three dimensional fabrication employing a rigid or flexible optically transparent window, a lubricant or immiscible liquid may be provided between the window and the polymerizable liquid (e.g., a fluorinated fluid or oil such as a perfluoropolyether oil).

From the foregoing it will be appreciated that, in some embodiments of bottom up or top down three dimensional fabrication as carried out in the context of the present invention, the growing three dimensional object or intermediate is fabricated in a layerless manner during the formation of at least one portion thereof, and that same growing three dimensional object or intermediate is fabricated in a layer-by-layer manner during the formation of at least one other portion thereof. Thus, operating mode may be changed once, or on multiple occasions, between layerless fabrication and layer-by-layer fabrication, as desired by operating conditions such as part geometry.

In preferred embodiments, the intermediate is formed by continuous liquid interface production (CLIP). CLIP is known and described in, for example, PCT Applications Nos. PCT/US2014/015486 (published as U.S. Pat. No. 9,211,678 on Dec. 15, 2015); PCT/US2014/015506 (also published as U.S. Pat. No. 9,205,601 on Dec. 8, 2015), PCT/US2014/015497 (also published as U.S. 2015/0097316, and to publish as U.S. Pat. No. 9,216,546 on Dec. 22, 2015), and in J. Tumbleston, D. Shirvanyants, N. Ermoshkin et al., Continuous liquid interface production of 3D Objects, Science 347, 1349-1352 (published online 16 Mar. 2015). The disclosures of the aforementioned patents are hereby incorporated by reference herein in their entireties. In some embodiments, CLIP employs features of a bottom up three dimensional fabrication as described above, but the irradiating and/or said advancing (or rotating) steps are carried out while also concurrently maintaining a stable or persistent liquid interface between the growing object and the build surface or window, such as by: (i) continuously maintaining a dead zone of polymerizable liquid in contact with said build surface, and (ii) continuously maintaining a gradient of polymerization zone (such as an active surface) between the dead zone and the solid polymer and in contact with each thereof, the gradient of polymerization zone comprising the first component in partially cured form. In some embodiments of CLIP, the optically transparent member comprises a semipermeable member (e.g., a fluoropolymer), and the continuously maintaining a dead zone is carried out by feeding an inhibitor of polymerization through the optically transparent member, thereby creating a gradient of inhibitor in the dead zone and optionally in at least a portion of the gradient of polymerization zone.

In some embodiments, the stable liquid interface may be achieved by other techniques, such as by providing an immiscible liquid as the build surface between the polymerizable liquid and the optically transparent member, by feeding a lubricant to the build surface (e.g., through an optically transparent member which is semipermeable thereto, and/or serves as a reservoir thereof), etc.

While the dead zone and the gradient of polymerization zone do not have a strict boundary therebetween (in those locations where the two meet), the thickness of the gradient of polymerization zone is in some embodiments at least as great as the thickness of the dead zone. Thus, in some embodiments, the dead zone has a thickness of from 0.01, 0.1, 1, 2, or 10 microns up to 100, 200 or 400 microns, or more, and/or the gradient of polymerization zone and the dead zone together have a thickness of from 1 or 2 microns up to 400, 600, or 1000 microns, or more. Thus the gradient of polymerization zone may be thick or thin depending on the particular process conditions at that time. Where the gradient of polymerization zone is thin, it may also be described as an active surface on the bottom of the growing three-dimensional object, with which monomers can react and continue to form growing polymer chains therewith. In some embodiments, the gradient of polymerization zone, or active surface, is maintained (while polymerizing steps continue) for a time of at least 5, 10, 15, 20 or 30 seconds, up to 5, 10, 15 or 20 minutes or more, or until completion of the three-dimensional product.

Inhibitors, or polymerization inhibitors, for use in the present invention may be in the form of a liquid or a gas. In some embodiments, gas inhibitors are preferred. In some embodiments, liquid inhibitors such as oils or lubricants may be employed. In further embodiments, gas inhibitors which are dissolved in liquids (e.g. oils or lubricants) may be employed. For example, oxygen dissolved in a fluorinated fluid. The specific inhibitor will depend upon the monomer being polymerized and the polymerization reaction. For free radical polymerization monomers, the inhibitor can conveniently be oxygen, which can be provided in the form of a gas such as air, a gas enriched in oxygen (optionally but in some embodiments preferably containing additional inert gases to reduce combustibility thereof), or in some embodiments pure oxygen gas. In alternate embodiments, such as where the monomer is polymerized by photoacid generator initiator, the inhibitor can be a base such as ammonia, trace amines (e.g. methyl amine, ethyl amine, di and trialkyl amines such as dimethyl amine, diethyl amine, trimethyl amine, triethyl amine, etc.), or carbon dioxide, including mixtures or combinations thereof.

The method may further comprise the step of disrupting the gradient of polymerization zone for a time sufficient to form a cleavage line in the three-dimensional object (e.g., at a predetermined desired location for intentional cleavage, or at a location in the object where prevention of cleavage or reduction of cleavage is non-critical), and then reinstating the gradient of polymerization zone (e.g. by pausing, and resuming, the advancing (or rotating) step, increasing, then decreasing, the intensity of irradiation, and combinations thereof).

The build plate or window may be configured such that air, oxygen or other polymerization inhibitor gases pass through the build plate to the polymerizable fluid (e.g., resin) on the build surface. For example, the build plate may include a flexible sheet or film, such as a semipermeable (or gas permeable) member (e.g., perfluoropolymers, such as TEFLON AF® fluoropolymers, alone or in combination with one or more additional supporting members (e.g., clamps and tensioning members to rigidify an otherwise flexible semipermeable material, or another layer, such as a rigid support layer under the sheet. The support layer may be gas permeable (porous glass, laser-cut glass, silicon, quartz, sapphire or polymer materials in which apertures through the layer are cut with a laser). Gas-impermeable supports may also be used in various configurations such that gas flow is still permitted to flow to the build surface, for example, using channels or uneven surface topologies. In some cases, layered build plates may be used, including permeable or impermeable channel layers having patterned or uneven surface topologies to increase a flow of gas to the build surface. The layers may be laminated or bonded using an adhesive, such as a gas permeable adhesive such as a poly(dimethylsiloxane) (PDMS) film. Flexible layers that may oscillate during a build process may be used. In some embodiments, gas supply and/or pressure controllers (e.g., vacuum pumps) may be used to control the gas and/or pressure of the gas applied to the build surface through the build plate. Example configurations of build plates are described in PCT Applications PCT/US2016/012303, filed Jan. 6, 2016; PCT/US2016/013225, filed Jan. 13, 2016; PCT/US2016/015686, filed Jan. 29, 2016; PCT/US2016/015699, filed Jan. 29, 2016; PCT/US2016/022022, filed Mar. 11, 2016; and PCT/US2016/022039, filed Jan. 29, 2016, the disclosures of each of which are hereby incorporated by reference in their entireties.

CLIP may be carried out in different operating modes, including continuous, intermittent, reciprocal, and combinations thereof. These operating modes are described in PCT Patent Application Serial No. PCT/US2016/019839, the disclosure of which is incorporated by reference in its entirety

Thus in some embodiments, the advancing (or rotating) step is carried out continuously, at a uniform or variable rate, with either constant or intermittent illumination or exposure of the build area to the light source.

In other embodiments, the advancing (or rotating) step is carried out sequentially in uniform increments (e.g., of from 0.1 or 1 microns, up to 10 or 100 microns, or more) for each step or increment. In some embodiments, the advancing (or rotating) step is carried out sequentially in variable increments (e.g., each increment ranging from 0.1 or 1 microns, up to 10 or 100 microns, or more) for each step or increment. The size of the increment, along with the rate of advancing (or rotating), will depend in part upon factors such as temperature, pressure, structure of the article being produced (e.g., size, density, complexity, configuration, etc.).

In some embodiments, the rate of advance or rotation (whether carried out sequentially or continuously) is from about 0.1 1, or 10 microns per second, up to about to 100, 1,000, or 10,000 microns per second, again depending again depending on factors such as temperature, pressure, structure of the article being produced, intensity of radiation, etc.

In still other embodiments, the carrier or object is vertically reciprocated with respect to the build surface to enhance or speed the refilling of the build region with the polymerizable liquid (e.g., by reversing the direction of the rotating). In some embodiments, the vertically reciprocating step, which comprises an upstroke and a downstroke, is carried out with the distance of travel of the upstroke being greater than the distance of travel of the downstroke, to thereby concurrently carry out the advancing step (that is, driving the carrier or object away from the build plate in the Z dimension) in part or in whole.

In some embodiments, the solidifiable or polymerizable liquid is changed at least once during the method with a subsequent solidifiable or polymerizable liquid (e.g., by switching a “window” or “build surface” and associated reservoir of polymerizable liquid in the apparatus); optionally where the subsequent solidifiable or polymerizable liquid is cross-reactive with each previous solidifiable or polymerizable liquid during the subsequent curing, to form an object having a plurality of structural segments covalently coupled to one another, each structural segment having different structural (e.g., tensile) properties (e.g., a rigid funnel or liquid connector segment, covalently coupled to a flexible pipe or tube segment).

Once the three-dimensional intermediate is formed, it may be optionally washed, any supports optionally removed, any other modifications optionally made (cutting, welding, adhesively bonding, joining, grinding, drilling, etc.), and then—when dual cure polymerizable liquids are employed—heated and/or microwave irradiated sufficiently to further cure the resin and form the three dimensional object. Of course, additional modifications may also be made following the heating and/or microwave irradiating step.

Washing may be carried out with any suitable organic or aqueous wash liquid, or combination thereof, including solutions, suspensions, emulsions, microemulsions, etc. Examples of suitable wash liquids include, but are not limited to water, alcohols (e.g., methanol, ethanol, isopropanol, etc.), benzene, toluene, etc. Such wash solutions may optionally contain additional constituents such as surfactants, etc. A currently preferred wash liquid is a 50:50 (volume:volume) solution of water and isopropanol. Wash methods such as those described in U.S. Pat. No. 5,248,456 may be employed and are included herein.

After the intermediate is formed, optionally washed, etc., as described above, it is then heated and/or microwave irradiated to further cure the same. Heating may be active heating (e.g., in an oven, such as an electric, gas, or solar oven), or passive heating (e.g., at ambient temperature). Active heating will generally be more rapid than passive heating and in some embodiments is preferred, but passive heating—such as simply maintaining the intermediate at ambient temperature for a sufficient time to effect further cure—is in some embodiments preferred.

In some embodiments, the heating step is carried out at least a first temperature and a second temperature, with the first temperature greater than ambient temperature, the second temperature greater than the first temperature, and the second temperature less than 300° C. (e.g., with ramped or step-wise increases between ambient temperature and the first temperature, and/or between the first temperature and the second temperature).

For example, the intermediate may be heated in a stepwise manner at a first oven temperature of about 70° C. to about 150° C., and then at a second temperature of about 150° C. to 200 or 250° C., with the duration of each heating depending on the size, shape, and/or thickness of the intermediate. In another embodiment, the intermediate may be cured by a ramped heating schedule, with the temperature ramped from ambient temperature through a temperature of 70 to 150° C., and up to a final oven temperature of 250 or 300° C., at a change in heating rate of 0.5° C. per minute, to 5° C. per minute. (See, e.g., U.S. Pat. No. 4,785,075).

It will be clear to those skilled in the art that the materials described in the current invention will be useful in other additive manufacturing techniques, including ink jet printer-based methods.

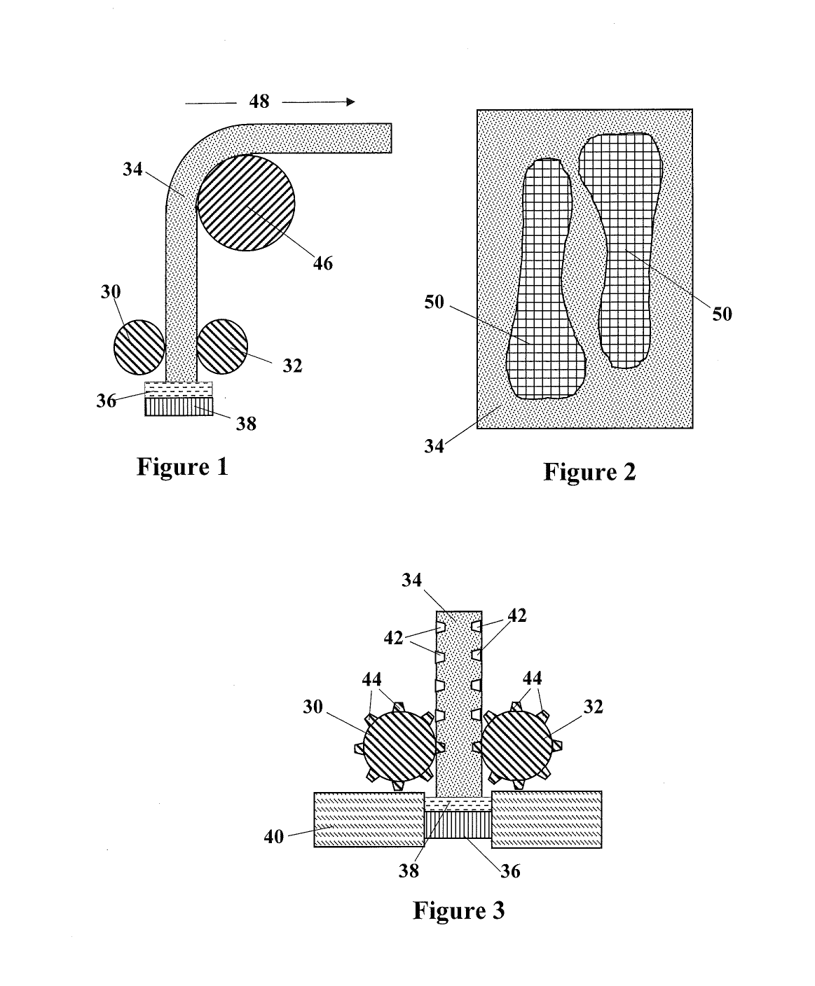

FIGS. 1-3 are schematic illustrations of a portion of an apparatus (three-dimensional printer) according to embodiments of the invention. The apparatus may be similar to that described above. A difference is that first and second drive rollers 30, 32 are employed instead of the carrier. The drive rollers 30, 32 are used to advance the three-dimensional object including a “continuous” sheet of material 34 away from the build region 36. As used herein, the term “continuous sheet of material” means an elongated sheet of material that has a length of 2, 5, 10, 20 feet or more. The continuous sheet of material may have structure (e.g., varied structure) in all three dimensions (e.g., similar to a 3D lattice).

The drive rollers 30, 32 are positioned near the window 38. As illustrated, the drive rollers 30, 32 are in or adjacent a frame 40 that may partially define the build region 36. The drive rollers are rotated (e.g., by one or more drive mechanisms and/or motors) to advance the sheet 34 away from the build region 36. In some embodiments, one of the rollers 30, 32 may be an idle or passive roller.

According to some embodiments, the sheet 34 includes pockets or tracks 42. The tracks 42 are recessed regions that are formed or “printed” as part of the three-dimensional object. The driver rollers 30, 32 may include projections, studs or teeth 44 that are received in the tracks 42 when the rollers 30, 32 are rotated to help advance the sheet 34.

A conveyor system may be used to convey the sheet of material 34 further away from the build region 36. The conveyor system may include a bending roller 46 that changes the path of the sheet of material 34 and helps convey the sheet 34 away in the direction indicated by arrow 48 in FIG. 2 (e.g., for further processing).

The sheet of material 34 may include outlined or perforated regions 50 that are or define objects or parts that are to be cut from the remainder of the sheet 34 as a later processing step. The objects may be, for example, insoles, midsoles, or soles for shoes. The objects may be cut from the sheet 34 using a water jet cutter or other suitable cutting mechanism.

The above-described arrangement may provide several advantages as will now be described.

The printer does not need to be stopped to remove parts—it prints continuously. This may be particularly advantageous when printing shoe components or other high volume objects.

The location of the drive rollers 30, 32 near the window 38 reduces any effect on print performance due to the compliance of the printed sheet 34. In other words, there is not very much material to stretch due to the position and/or size of the drive rollers 30, 32.

The resin bowl or build region 36 can be small and can be continuously replenished with fresh resin. The small size of the resin bowl reduces the risk of stagnant areas that can have pot life issues and can get “gummy.”

The window 38 is particularly small in the depth direction (corresponding to the thickness of the sheet 34). The window 38 could be a tensioned sheet (e.g., a fluoropolymer or poly(tetrafluoroethene) sheet such as a Teflon AF™ sheet) rather than a window with a more complex structure.

Illumination can be carried out using a rastered laser system. For example, a 1 W laser similar to that used on large commercial stereolithography (SLA) machines could continuously supply about 20 mW/cm² over the entire area of the window 38. Because the area of the window 38 is small, the effective power delivered to the area being printed is increased significantly.

The overall size of the printer may be reduced compared to those using a linear actuator system to advance the three-dimensional object. The loads may be considerably smaller and the load path is between the rollers 30, 32 and the adjacent window 38 rather than through a linear actuator system.

The window 38 and therefore the sheet 34 could be wider than as illustrated in FIGS. 1-3. In this regard, more objects such as shoe components could be printed along the width of the sheet 34.

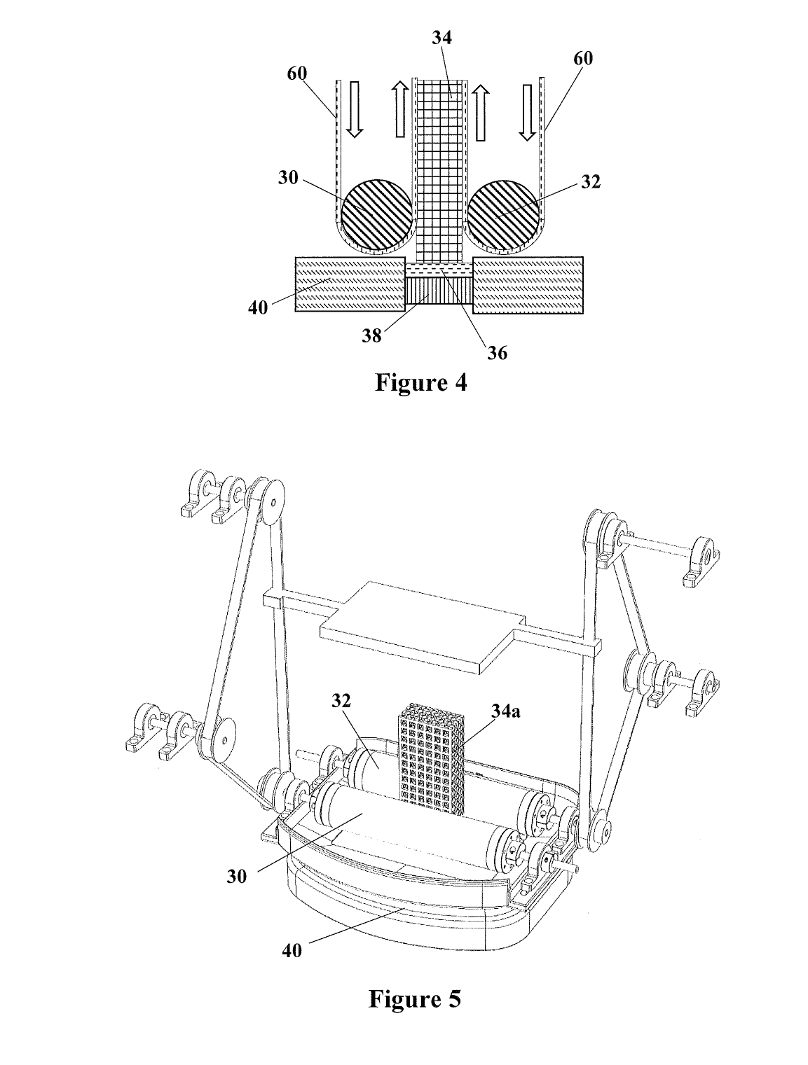

FIG. 4 illustrates an alternative arrangement to the rollers 30, 32 “grabbing” the sheet 34. A load bearing thin flexible substrate (or “web”) 60 such as a polymer film or mesh is provided to the rollers 30, 32 and the sheet 34 is enveloped with the film or mesh 60. The film or mesh 60 may bear the majority of the load. The load bearing thin flexible substrate 60 may alternatively be or include a metallic sheet or other type of synthetic sheet or mesh.

This arrangement may be advantageous because the film or mesh 60 may better distribute the pulling load from the rollers 30, 32 into the printed sheet 34. In addition, this arrangement may reduce the amount of resin needed for “non-revenue” portions of the sheet 34 (e.g., those portions including the recessed tracks shown in FIG. 3).

The film or mesh 60 may be peeled off or otherwise removed as a further processing step. Alternatively, the film or mesh 60 may serve as a reinforcing layer of the final part similar to rebar in concrete.

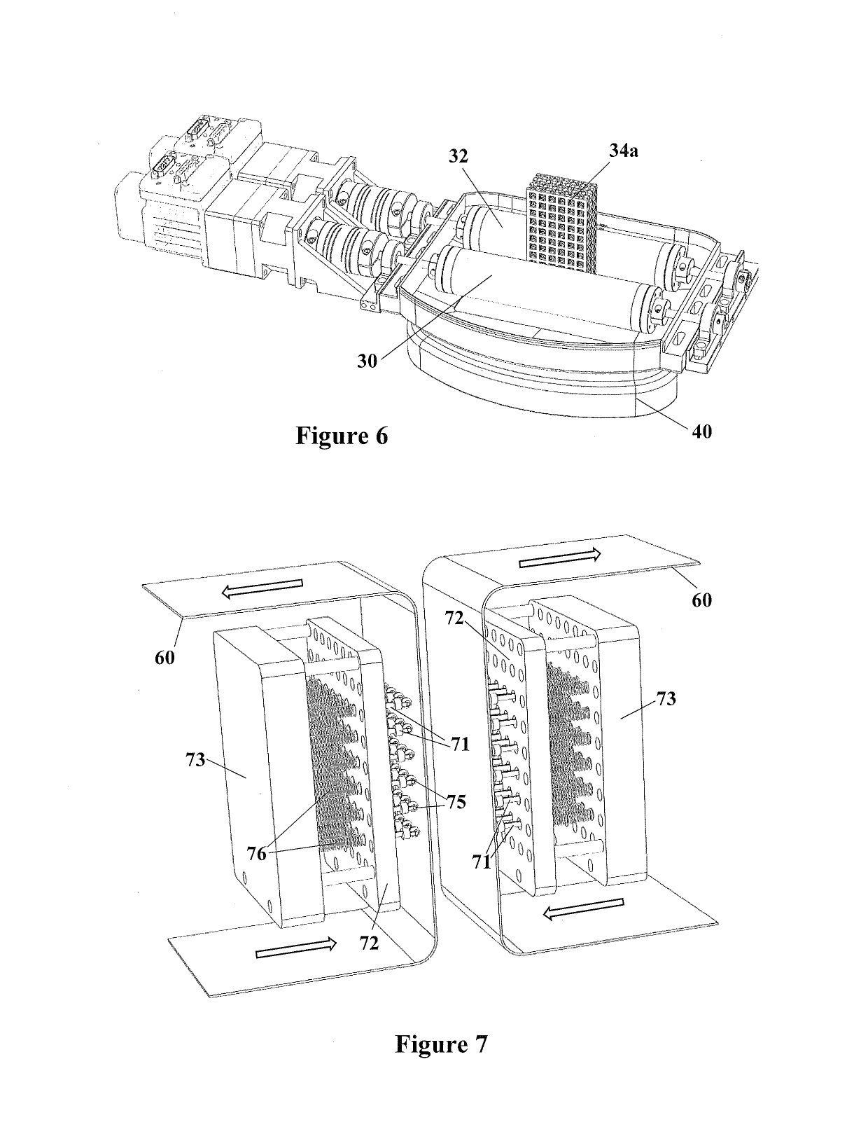

FIGS. 5-6 show a particular embodiment of an apparatus of FIGS. 1-3. Note that, to start production of the object, a pre-formed “priming” object 34a may be inserted between rollers 30, 32, the priming object having a bottom surface positioned adjacent the window, on which bottom surface the three-dimensional object may be formed. In some embodiments, the priming object may be flexible or elastic, to facilitate engagement by rollers 30, 32 (e.g., by pinching the priming object between the rollers). As illustrated, the priming object 34a may comprise a three-dimensional lattice, to facilitate the flow of resin into the priming object as it is immersed into, and advanced out of, the resin pool.

FIG. 7 shows a particular embodiment of the apparatus of FIG. 4, where a plurality of pushers 71 are applied to the surface of the web 60 on the side opposite said outer surfaces of the continuous sheet. The pushers are configured to enhance engagement of the web to the outer surfaces of the continuous sheet. As illustrated, the pushers 71 are mounted in a mounting plate 72 in an pusher array, and particularly an array that extends a plurality of pushers in both the vertical and horizontal directions. The pushers 71 are urged forward by springs 76 that are tensioned against pusher back plate 73, though other mechanisms such as pneumatically actuated pushers may also be used. The pushers as illustrated include terminal rollers 75 that ride on the web back surface, but other terminal portions such as skids, lubricious coatings, etc. (including combinations thereof) may also be employed.

The apparatus and methods described above can be used to produced rigid, flexible, or elastomeric parts, including parts comprising a three-dimensional lattice, particularly when producing such objects at high volume.

The foregoing is illustrative of the present invention, and is not to be construed as limiting thereof. The invention is defined by the following claims, with equivalents of the claims to be included therein.

What is claimed is:

1. A method of forming a three-dimensional object comprising a continuous sheet of material, the method comprising:
(a) providing at least one drive roller and a build plate, the build plate comprising an optically transparent member, the optically transparent member comprising a build surface, with the build surface at least partially defining a build region and the at least one drive roller adjacent the build region;
(b) filling the build region with a polymerizable liquid;
(c) irradiating the build region with light through the optically transparent member to form a solid polymer from the polymerizable liquid; and
(d) rotating the at least one drive roller to form the three-dimensional object from the solid polymer and/or to advance or draw the three-dimensional object including the continuous sheet of material away from the build region.

2. The method of claim 1 wherein the at least one drive roller comprises first and second drive rollers on opposite sides of the build plate.

3. The method of claim 2 wherein the first and second drive rollers engage opposite sides of the three-dimensional object.

4. The method of claim 3 wherein the first and second drive rollers are rotatable in or adjacent a frame.

5. The method of claim 4 wherein the build surface and the frame define the build region.

6. The method of claim 1, further comprising providing a conveyor mechanism above the at least one drive roller and operating the conveyor mechanism to advance the continuous sheet of material along the conveyor mechanism.

7. The method of claim 6 wherein the conveyor mechanism comprises a bending roller that allows the continuous sheet of material to bend before the continuous sheet of material advances along the conveyor mechanism.

8. The method of claim 1, wherein the build plate and/or the three-dimensional object has a width and a depth with the width being several times greater than the depth.

9. The method of claim 8 wherein the width is at least ten times greater than the depth.

10. The method of any claim 1, wherein the continuous sheet of material has a length of 5, 10, 15, 20 or more feet.

11. The method of claim 10 wherein the continuous sheet of material comprises outlined and/or perforated areas on an outer surface thereof.

12. The method of claim 11 wherein the outlined and/or perforated areas are configured to be cut out or otherwise removed from the remainder of the continuous sheet of material.

13. The method of claim 12 wherein the outlined and/or perforated areas are shoe components such as shoe insoles, shoe midsoles, or shoe soles.

14. The method of claim 1, wherein the continuous sheet of material comprises recessed tracks and the at least one drive roller comprises teeth, and wherein the teeth are received in respective ones of the tracks during the rotating step.

15. The method of claim 1, further comprising providing a pre-formed primer object having a bottom surface, with the bottom surface positioned adjacent the build surface and the primer object engaged by the at least one drive roller, with the method comprising forming the three-dimensional object on said bottom surface.

16. The method of claim 15, wherein said primer object comprises a three-dimensional lattice.

17. The method of claim 1, further comprising receiving or applying a web on or to one or both opposite outer surfaces of the continuous sheet of material during the rotating step.

18. The method of claim 17, further comprising applying a plurality of pushers to the surface of said web on the side opposite said outer surfaces of the continuous sheet, said pushers configured to enhance engagement of said web to said outer surfaces of said continuous sheet.

19. The method of claim 18, wherein said plurality of pushers comprises a two-dimensional pusher array.

20. The method of claim 1, wherein the filling, irradiating and/or rotating steps are carried out while also concurrently: (i) continuously maintaining a dead zone of polymerizable liquid in contact with the build surface, and (ii) continuously maintaining a gradient of polymerization zone between the dead zone and the solid polymer and in contact with each thereof, the gradient of polymerization zone comprising the polymerizable liquid in partially cured form.

21. The method of claim 20, wherein the optically transparent member comprises a semipermeable member, and the continuously maintaining a dead zone is carried out by feeding an inhibitor of polymerization through the optically transparent member in an amount sufficient to maintain the dead zone and the gradient of polymerization zone.

22. The method of claim 1, further comprising changing operating mode at least once during formation of the three-dimensional object for different contiguous segments of the continuous sheet of material.

23. The method of claim 22 wherein the operating mode is selected from the group consisting of: (a) continuous advancing with continuous exposure; (b) continuous advancing with intermittent exposure; (c) step-wise advancing with intermittent exposure; and (d) reciprocal advancing with intermittent exposure.

24. An apparatus for forming a three-dimensional object comprising a continuous sheet of material from a polymerizable liquid, the apparatus comprising:
(a) an optically transparent member having a build surface, with the build surface at least partially defining the build region;
(b) first and second drive rollers on opposite sides of and adjacent the build surface;
(c) a liquid polymer supply in fluid communication with and configured to supply a liquid polymer or polymerizable liquid into the build region for solidification or polymerization;
(d) a radiation source configured to irradiate the build region through the optically transparent member to form a solid polymer from the polymerizable liquid; and
(e) at least one controller operatively associated with the first and second drive rollers and the radiation source for rotating the first and second drive rollers to form the three-dimensional object from the solid polymer and to advance the continuous sheet of material away from the build surface.

25. The apparatus of claim 24 wherein the first and second drive rollers engage opposite side surfaces of the three-dimensional object.

26. The apparatus of claim 24, further comprising a frame with the first and second drive rollers being rotatable in or adjacent the frame.

27. The apparatus of claim 26 wherein the build surface and the frame define the build region.

28. The apparatus of claim 24 further comprising a conveyor mechanism above the at least one drive roller, wherein the at least one controller is configured to operate the conveyor mechanism to advance the continuous sheet of material along the conveyor mechanism.

29. The apparatus of claim 28 wherein the conveyor mechanism comprises a bending roller that allows the continuous sheet of material to bend before the continuous sheet of material advances along the conveyor mechanism.

30. The apparatus of claim 24 wherein the build surface and/or the three-dimensional object has a width and a depth with the width being several times greater than the depth.

31. The apparatus of claim 30 wherein the width is at least ten times greater than the depth.

32. The apparatus of claim 24 wherein the continuous sheet of material has a length of 5, 10, 15, 20 or more feet.

33. The apparatus of claim 32 wherein the continuous sheet of material comprises outlined and/or perforated areas on an outer surface thereof.

34. The apparatus of claim 33 wherein the outlined and/or perforated areas are configured to be cut out or otherwise removed from the remainder of the continuous sheet of material.

35. The apparatus of claim 34 wherein the outlined and/or perforated areas are shoe components such as shoe insoles, shoe midsoles, or shoe soles.

36. The apparatus of claim 24 wherein the continuous sheet of material comprises recessed tracks and at least one of the first and second drive roller comprises studs, and wherein the studs are received in respective ones of the tracks when the first and second drive rollers are rotated.

37. The apparatus of claim 24 further comprising a web configured to be applied to or received on one or both opposite outer surfaces of the continuous sheet of material during the rotating step.

38. The apparatus of claim 37, further comprising a plurality of pushers configured for application to the surface of said web on the side opposite said outer surfaces of the continuous sheet, said pushers configured to enhance engagement of said web to said outer surfaces of said continuous sheet.

39. The apparatus of claim 38, wherein said plurality of pushers comprises a two-dimensional pusher array.

40. The apparatus of claim 24 wherein the at least one controller is operatively associated with the first and second drive rollers and the radiation source to form the three-dimensional object from the solid polymer and to advance the continuous sheet of material away from the build surface, while also concurrently: (i) continuously maintaining a dead zone of polymerizable liquid in contact with the build surface; and (ii) continuously maintaining a gradient of polymerization zone between the dead zone and the solid polymer and in contact with each thereof, the gradient of polymerization zone comprising the polymerizable liquid in partially cured form.

41. The apparatus of claim 40 wherein the optically transparent member comprises a semipermeable member.

42. The apparatus of claim 41 wherein: the semipermeable member comprises a top surface portion, a bottom surface portion, and an edge surface portion; the build surface is on the top surface portion; a feed surface is on at least one of the top surface portion, the bottom surface portion, and the edge surface portion; and the apparatus further comprising a polymerization inhibitor source in fluid communication with the feed surface.
